(19) United States
(12) Patent Application Publication
(10) Pub. No.: US 2014/0098333 A1
(43) Pub. Date: Apr. 10, 2014

(54) LIQUID CRYSTAL DISPLAY AND MANUFACTURING METHOD THEREOF

(71) Applicant: SAMSONG DISPLAY CO., LTD., Yongin-city (KR)

(72) Inventors: Cheol Kyu KIM, Seoul (KR); Suk Won Jung, Goyang-si (KR); Sung Hoon Yang, Seoul (KR); Hee Young Lee, Suwon-si (KR)

(73) Assignee: Samsung Display Co., Ltd., Yongin-city (KR)

(21) Appl. No.: 13/836,728

(22) Filed: Mar. 15, 2013

(30) Foreign Application Priority Data
Oct. 10, 2012 (KR) 10-2012-0112461

(51) Int. Cl. G02F 1/1343; G02F 1/1335

(52) U.S. Cl. CPC G02F 1/1343; G02F 1/133514
USPC 349/106; 349/138; 349/139; 445/24

(57) ABSTRACT

The present invention relates to a liquid crystal display including: an substrate; a microcavity formed on the substrate; a pixel electrode formed in the microcavity and having a domain divider on the substrate; a liquid crystal layer positioned in the microcavity layer; and a common electrode positioned on the liquid crystal layer and having a domain divider.

### CROSS-REFERENCE TO RELATED APPLICATION

This application claims priority from and the benefit of Korean Patent Application No. 10-2012-0112461, filed in the Korean Intellectual Property Office on Oct. 10, 2012, the entire contents of which are incorporated herein by reference.

### BACKGROUND

1. Field

The present invention relates to a liquid crystal display and a manufacturing method thereof, and in detail, to a liquid crystal display having a liquid crystal layer disposed in a microcavity, and a manufacturing method thereof.

2. Discussion of the Background

A liquid crystal display as one of flat panel display devices that are widely used includes two display panels where field generating electrodes such as pixel electrodes and a common electrode are formed, and a liquid crystal layer interposed therebetween.

The liquid crystal display generates an electric field in the liquid crystal layer by applying voltages to the field generating electrodes, to determine orientations of liquid crystal molecules of the liquid crystal layer and control polarization of incident light, thereby displaying an image.

The liquid crystal display having an EM (embedded microcavity) structure or a nanocrystal structure is a device in which a sacrificial layer such as a organic material is formed, a supporting member is coated thereon, then the sacrificial layer is removed, and a liquid crystal is filled in an empty space formed by removal of the sacrificial layer for displaying.

However, in the conventional liquid crystal display in which the liquid crystal molecules filled in the microcavity have a vertically aligned structure, and the upper and lower electrodes have a single voltage, lateral visibility may be deteriorated.

The above information disclosed in this Background section is only for enhancement of understanding of the background of the invention and therefore it may contain information that does not form the prior art that is already known in this country to a person of ordinary skill in the art.

### SUMMARY OF THE INVENTION

Exemplary embodiment of the present invention provides a liquid crystal display having a liquid crystal layer in a microcavity thereby improving lateral visibility.

Additional features of the invention will be set forth in the description which follows, and in part will be apparent from the description, or may be learned by practice of the invention.

A liquid crystal display according to an exemplary embodiment of the present invention includes: a substrate; a microcavity disposed on the substrate; a pixel electrode disposed in the microcavity and on the substrate, the pixel electrode having a domain divider; a liquid crystal layer disposed in the microcavity layer; and a common electrode disposed on the liquid crystal layer and having a domain divider.

The domain divider of the pixel electrode includes a cutout, a protrusion, a notch, a depression or any combination of the cutout, protrusion, notch, and depression, and the domain divider of the common electrode includes a cutout, a protrusion, a notch, a depression or any combination of the cutout, protrusion, notch, and depression.

The domain divider of the common electrode is positioned between the domain divider of the pixel electrode.

The domain divider of the common electrode is a different type of domain divider than the domain divider of the pixel electrode.

A manufacturing method of a liquid crystal display according to an exemplary embodiment of the present invention includes: forming a pixel electrode on a substrate, the pixel electrode having a domain divider; forming a sacrificial layer on the pixel electrode; forming an etch stopper on the sacrificial layer; forming a common electrode on the etch stopper, the common electrode having a domain divider; forming a roof layer on the common electrode; forming a microcavity by removing the sacrificial layer; and injecting a liquid crystal to the microcavity layer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a cross-sectional view of a liquid crystal display according to an exemplary embodiment of the present invention.

FIG. 2, FIG. 3, FIG. 4, FIG. 5, and FIG. 6 are cross-sectional views according to a manufacturing sequence of the liquid crystal display of FIG. 1.

FIG. 7 is a cross-sectional view of a liquid crystal display according to another exemplary embodiment of the present invention.

FIG. 8, FIG. 9, FIG. 10, FIG. 11, FIG. 12, FIG. 13, and FIG. 14 are cross-sectional views according to a manufacturing sequence of the liquid crystal display of FIG. 7.

FIG. 15 is a layout view of a pixel structure in a liquid crystal display according to an exemplary embodiment of the present invention.

FIG. 16 is an equivalent circuit diagram of one pixel of a liquid crystal display according to an exemplary embodiment of the present invention.

FIG. 17 is a view of two electrodes for two sub-pixels of a liquid crystal display according to an exemplary embodiment of the present invention.

FIG. 18 is a cross-sectional view of a liquid crystal display according to another exemplary embodiment of the present invention.

### DETAILED DESCRIPTION OF THE ILLUSTRATED EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

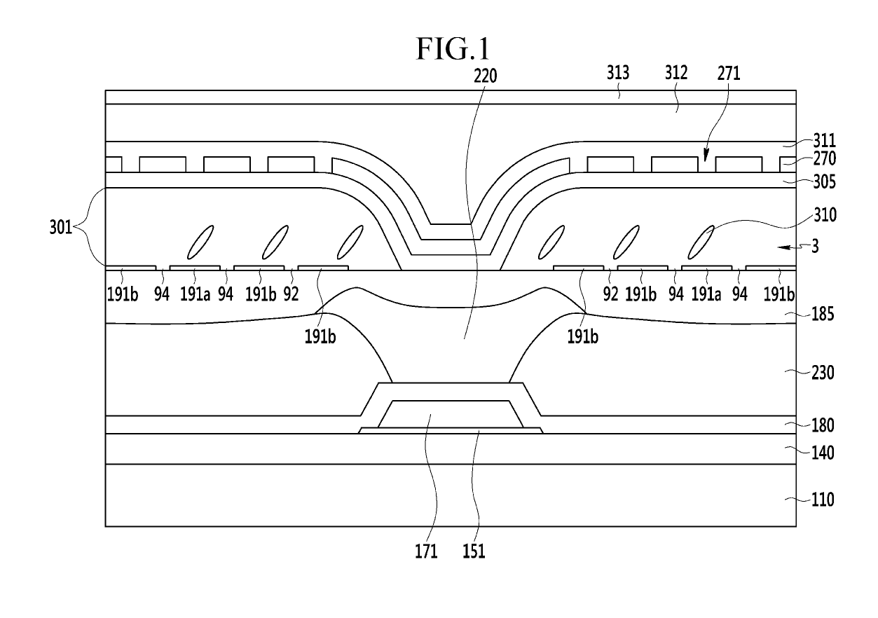

Now, a liquid crystal display according to an exemplary embodiment of the present invention will be described with reference to FIG. 1.

FIG. 1 is a cross-sectional view of a liquid crystal display according to an exemplary embodiment of the present invention.

Referring to a structure of FIG. 1, wiring and a thin film transistor are formed on an insulation substrate 110 made of transparent glass or plastic, and two sub-pixel electrodes 191a and 191b are formed thereon. The two sub-pixel electrodes 191a and 191b are formed in a microcavity layer, and a common electrode 270 is formed on the microcavity layer. In FIG. 1, cutouts 92 and 271 as an exemplary embodiment of a domain divider are formed in the two sub-pixel electrodes 191a and 191b, and the common electrode 270, respectively. Alternatively, instead of the cutout, a protrusion, depression, notch, or any combination of the cutout, protrusion, depression, and notch may be formed according to an exemplary embodiment. The domain divider of the common electrode may be different type of domain divider than the domain divider of the pixel electrode according to an exemplary embodiment. The two sub-pixel electrodes 191a and 191b may be applied with different voltages.

Next, a structure of the liquid crystal display according to an exemplary embodiment of the present invention will be described.

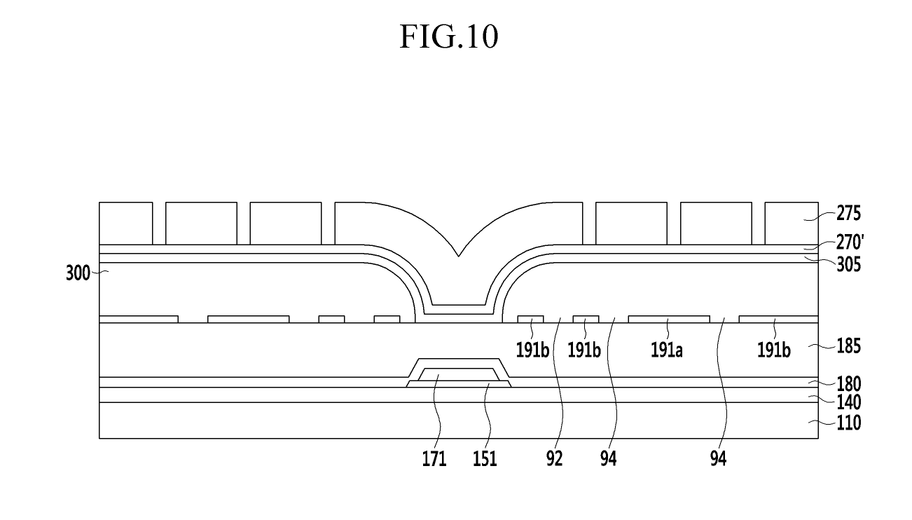

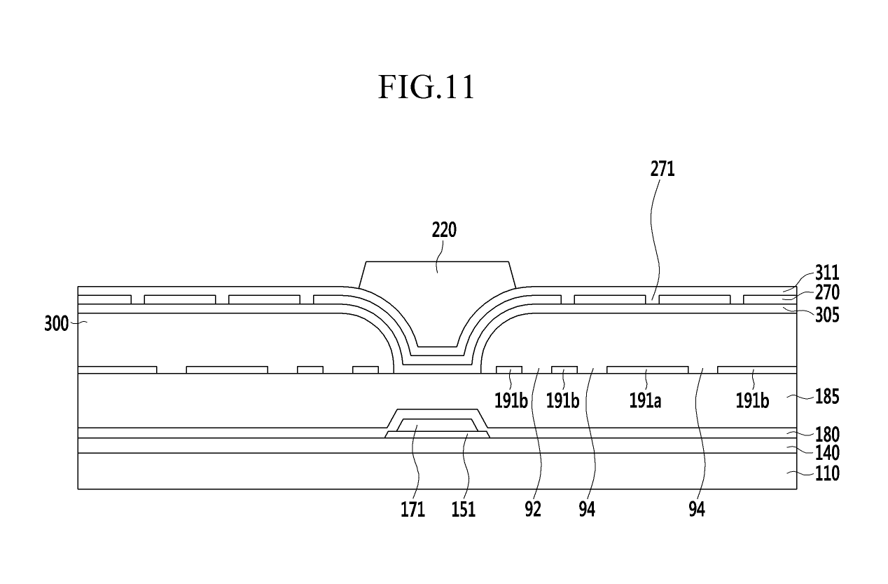

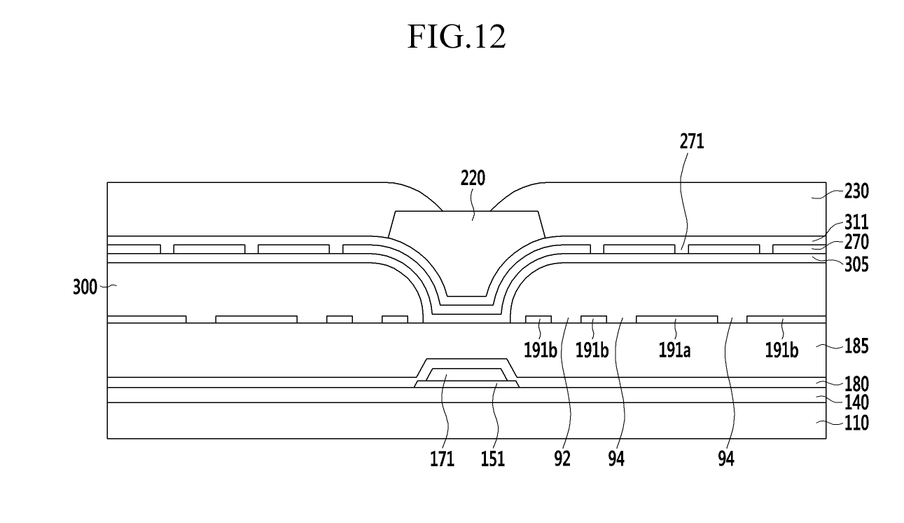

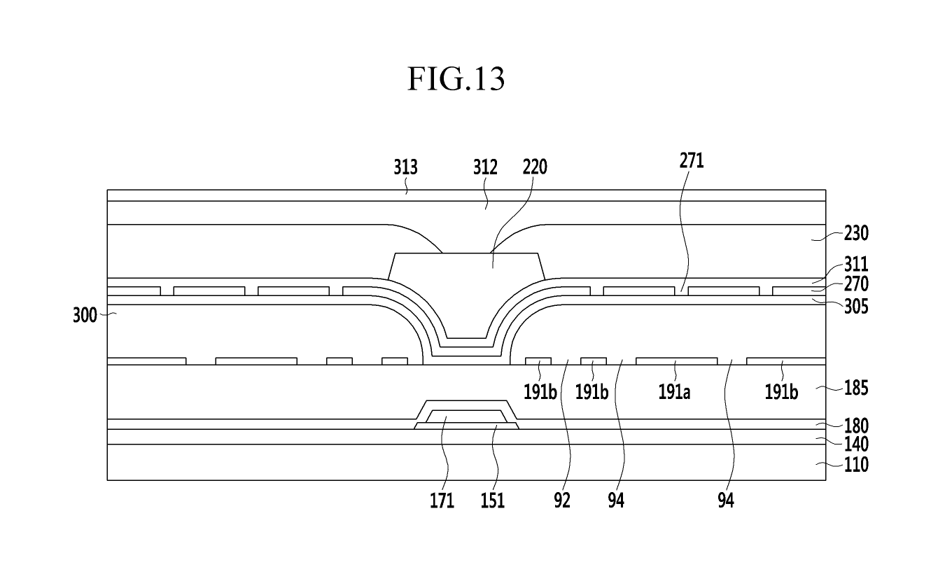

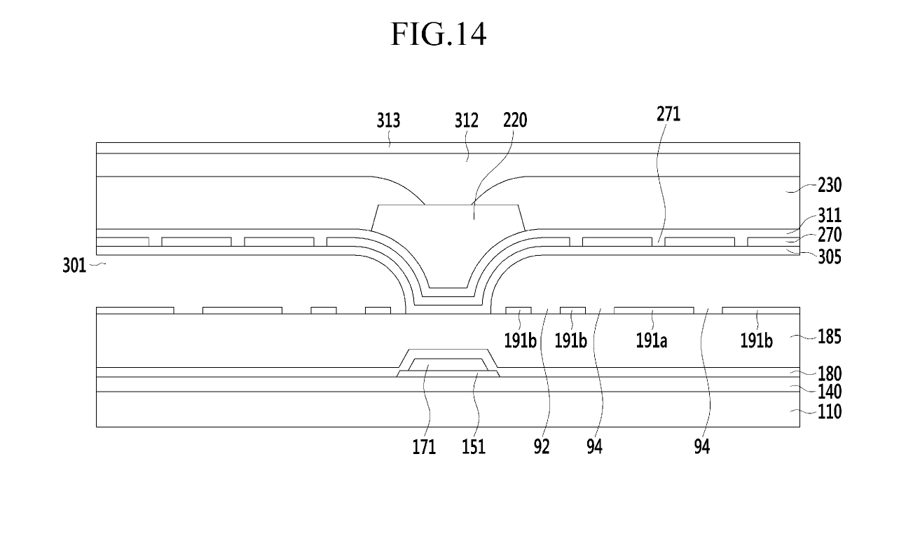

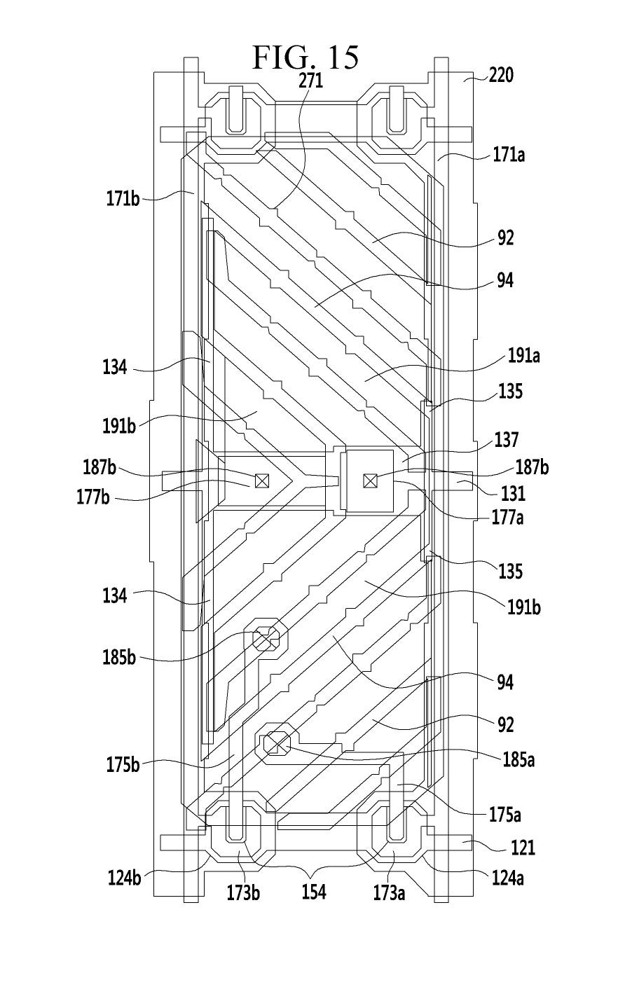

A gate line 121 (referring to FIG. 15) is formed on the insulation substrate 110 made of transparent glass or plastic. The gate line extends in one direction and includes two gate electrodes 124a and 124b (referring to FIG. 15) that are protruded therefrom.

A gate insulating layer 140 is formed on the gate line. A semiconductor layer is formed on the gate insulating layer 140, and the semiconductor layer may include a semiconductor 151 positioned under the data line 171, a semiconductor positioned under source/drain electrodes (referring to 173a, 173b, 175a, and 175b of FIG. 15), and a semiconductor (154 referring to FIG. 15) positioned under a channel portion of a thin film transistor. A plurality of ohmic contacts may be formed between the semiconductor 151 and the source/drain electrodes.

A data conductor including a plurality of data lines 171 including the source electrodes and the drain electrodes is formed on each semiconductor 151 and the gate insulating layer 140.

The gate electrode, the source electrode, and the drain electrode form a thin film transistor along with the semiconductor of the channel portion. At least one thin film transistor is formed in one pixel.

A first passivation layer 180 is formed on the data conductor and the exposed semiconductor. The first passivation layer 180 may include an inorganic insulator or an organic insulator such as silicon nitride (SiNx) and silicon oxide (SiOx).

A color filter 230 is formed on the first passivation layer 180. Color filters 230 of the same color may be formed in pixels adjacent in a vertical direction (a data line direction). Also, color filters 230 of different colors may be formed in the pixels adjacent in a horizontal direction (a gate line direction). However, the allocation of color filters 230 may be varied depending on the application of liquid crystal display. In FIG. 1, two color filters 230 are separated by a predetermined interval on the data line 171. However, according to an exemplary embodiment, two color filters 230 may overlap each other. Each color filter 230 may display one of primary colors such as three primary colors including red, green, and blue. However, it is not limited to three primary colors such as red, green, and blue, and may display one of cyan, magenta, yellow, and white-based colors.

A light blocking member (black matrix; 220) is formed on the color filter 230. The light blocking member 220 is formed with respect to a region where the gate line 121, the thin film transistor, and the data line 171 are formed, and has a lattice structure having openings corresponding to a region where an image is displayed. A color filter 230 is formed in the opening of the light blocking member 220.

The up and down relation of the color filter 230 and the light blocking member 220 may be exchanged.

A second passivation layer 185 is formed on the color filter 230 and the light blocking member 220. The second passivation layer 185 may include the inorganic insulator such as silicon nitride (SiNx) and silicon oxide (SiOx) or the organic insulator, and uses the organic insulator in the exemplary embodiment of FIG. 1, and provides a flat surface. According to an exemplary embodiment, one of the first passivation layer 180 and the second passivation layer 185 may be omitted.

The sub-pixel electrodes 191a and 191b are formed on the second passivation layer 185. The sub-pixel electrodes 191a and 191b are formed of a transparent conductive material such as Indium Tin Oxide (ITO) or Indium Zinc Oxide (IZO).

The first sub-pixel electrode 191a and the second sub-pixel electrode 191b are separated by a gap 94, and the first sub-pixel electrode 191a and the second sub-pixel electrode 191b include cutouts 92 as the domain divider. The gap 94 and the cutout 92 may include a portion that is obliquely formed with respect to the gate line 121 or the data line 171.

The sub-pixel electrodes 191a and 191b are electrically connected to the drain electrode 175 through a contact hole formed in the first passivation layer 180 and the second passivation layer 185, thereby receiving a data voltage.

A microcavity 301 is formed on the second passivation layer 185, and the sub-s pixel electrodes 191a and 191b. A liquid crystal layer 3 is formed in the microcavity layer. The liquid crystal layer 3 has dielectric anisotropy. Liquid crystal molecules 310 of the liquid crystal layer 3 may be arranged such that longitudinal axes of the liquid crystal molecules are perpendicular to the surfaces of the two panels in the absence of application of an electric field.

According to an exemplary embodiment, an alignment layer may be formed in the microcavity 301. However, to control an initial arrangement direction of the liquid crystal molecules 310, an exposure process using ultraviolet rays may not be performed.

Liquid crystal may be injected into the microcavity 301 by using a capillary force, and the alignment layer may be formed by the capillary force. An alignment direction of the liquid crystal molecules 310 included in the liquid crystal layer 3 is changed according to the electric field formed by the sub-pixel electrodes 191a and 191b and the common electrode 270.

An etch stopper 305 is formed on the microcavity 301. The etch stopper 305 is a layer protecting a sacrificial layer 300 to not be etched when etching the sacrificial layer 300 to form the cutout 271 in the overlying common electrode 270 in the manufacturing process. The etch stopper 305 may be made of a material that is not etched under the etching of the common electrode 270, and various materials including the inorganic insulator such as silicon nitride (SiNx) and silicon oxide (SiOx) may be used. Also, if a material that is etched under the etching of the common electrode 270 is used as the etch stopper 305, the etch stopper 305 may be formed with sufficient thickness to protect the underlying sacrificial layer 300.

The common electrode 270 is formed on the etch stopper 305. The common electrode 270 is formed of the transparent conductive material such as Indium Tin Oxide (ITO) or Indium Zinc Oxide (IZO), and includes the cutouts 271 as a domain divider. Each cutout 271 of the common electrode 270 is positioned between a cutout 92 and a gap 94 of the sub-pixel electrodes 191a and 191b and includes a portion parallel to the cutout 92 or the gap 94. The cutout 271 of the common electrode 270 may include a portion that is obliquely formed with respect to the gate line 121 or the data line 171.

A lower insulating layer 311 is positioned on the common electrode 270. The lower insulating layer 311 may include the inorganic insulating material such as silicon nitride (SiNx). The lower insulating layer 311 covers the cutout 271 of the common electrode 270.

A roof layer 312 is formed on the lower insulating layer 311. The roof layer 312 may have a supporting function to form the microcavity layer. The roof layer 312 according to the present exemplary embodiment has a function of supporting the microcavity 301 along with the etch stopper 305, the common electrode 270, and the lower insulating layer 311, and may have a liquid crystal injection hole (not shown) formed at one side such that liquid crystal may be injected to the microcavity 301.

An upper insulating layer 313 is formed on the roof layer 312. The upper insulating layer 313 may include the inorganic insulating material such as silicon nitride (SiNx). The roof layer 312 and the upper insulating layer 313 may be patterned along with the lower insulating layer 311, the common electrode 270, and the etch stopper 305 to form the liquid crystal injection hole. The liquid crystal injection hole is used to remove the sacrificial layer 300 to form the microcavity 301 and to inject the liquid crystal layer to the microcavity 301. Next, the liquid crystal injection hole is sealed by a capping layer (not shown) for the liquid crystal material to not flow out.

A polarizer (not shown) is positioned on the lower and upper insulating layers 311 and 313 of the insulation substrate 110. The polarizer includes a polarization element for polarization and a triacetylcellulose (TAC) layer for ensuring durability, and directions of transmissive axes in an upper polarizer and a lower polarizer may be perpendicular or parallel to each other according to an exemplary embodiment.

As described above, in the liquid crystal display according to an exemplary embodiment of the present invention, the liquid crystal layer 3 is formed in the microcavity layer. The two sub-pixel electrodes 191a and 191b under the liquid crystal layer and the common electrode 270 on the liquid crystal layer respectively have the domain divider (the cutouts 92 in FIG. 1), and thereby the liquid crystal molecules 310 included in one pixel are controlled to be aligned in the various direction for forming multi-domains such that the lateral visibility is improved. Referring to FIG. 15, in the present exemplary embodiment, the liquid crystal molecules 310 are inclined in a total of four directions.

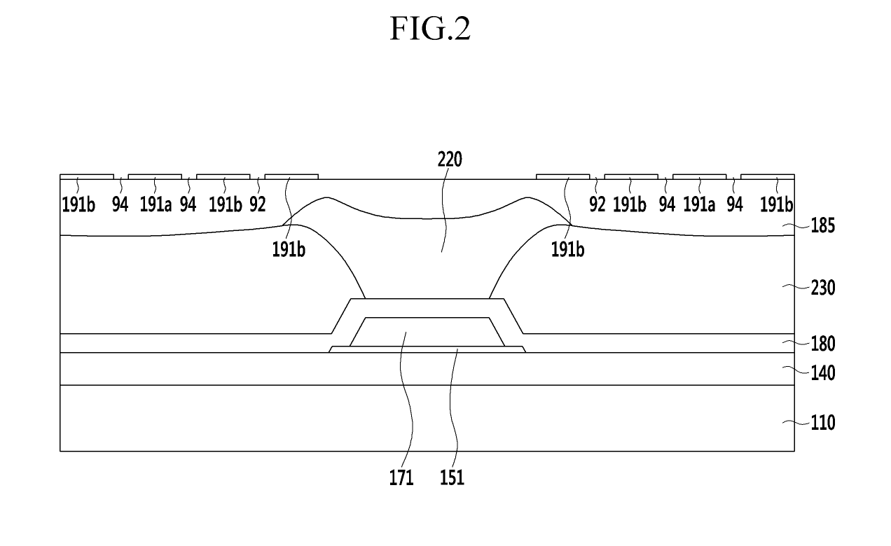

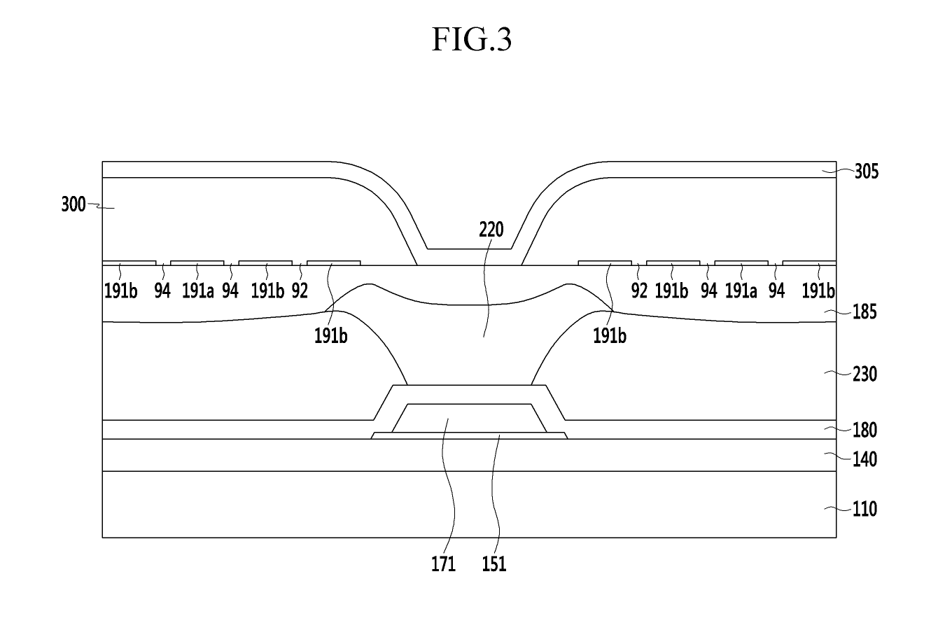

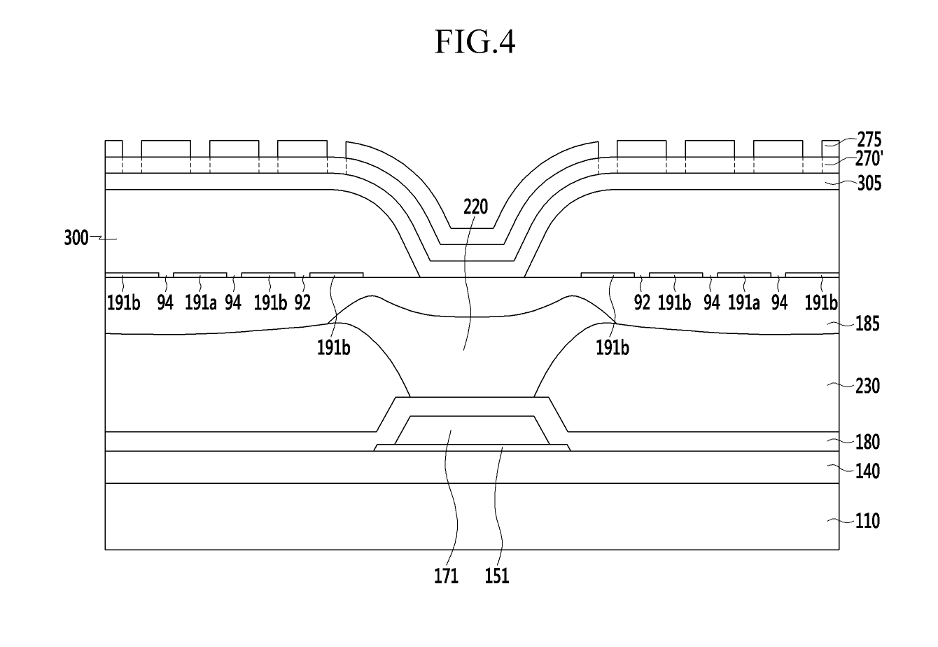

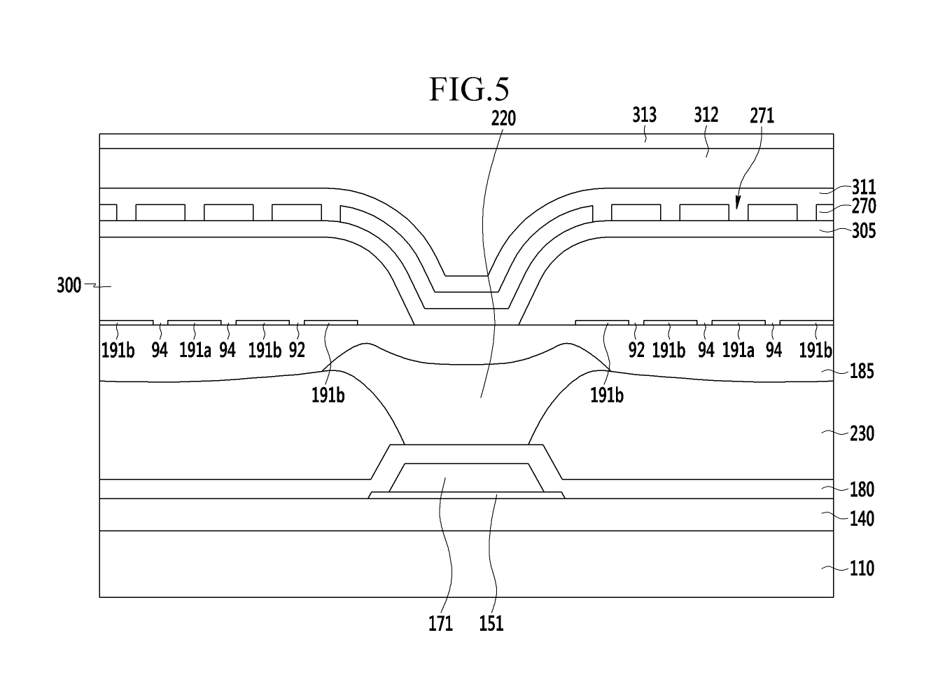

A manufacturing method for the exemplary embodiment of FIG. 1 will be described with reference to FIG. 2 , FIG. 3, FIG. 4, FIG. 5, and FIG. 6.

FIG. 2 , FIG. 3, FIG. 4, FIG. 5, and FIG. 6 are cross-sectional views according to a manufacturing sequence of the liquid crystal display of FIG. 1.

Firstly, as shown in FIG. 2, a gate line 121 (referring to FIG. 15) is formed on an insulation substrate 110 made of transparent glass or plastic, and a gate insulating layer 140 is deposited thereon. A semiconductor material and a metal for a data line are sequentially deposited and are patterned by using one mask (a slit mask or a transflective mask) to form a semiconductor 151 and a source and a drain electrode (referring to 173a, 173b, 175a, and 175b of FIG. 15), and a data line 171. A first passivation layer 180 covering them is deposited and a color filter 230 is formed thereon. A light blocking member 220 having an opening corresponding to the color filter 230 is formed and a second passivation layer 185 covering the light blocking member 220 is formed. A contact hole (referring to 185a and 185b of FIG. 15) exposing the drain electrode is formed in the first passivation layer 180 and the second passivation layer 185. A transparent conductive material is deposited on the second passivation layer 185 and etched to form two sub-pixel electrodes 191a and 191b having a gap 94 and a cutout 92. Here, each sub-pixel electrode is connected to the drain electrode through the contact hole.

In FIG. 2, steps of forming the wiring, the thin film transistor, the sub-pixel electrode, and the common electrode are omitted and are shown as one view. This structure may be realized by various exemplary embodiments.

As shown in FIG. 3, a sacrificial layer 300 is formed by using a photoresist (PR). That is, a photoresist (PR) material is deposited, and exposed and developed to form the sacrificial layer 300. The sacrificial layer 300 is removed later thereby forming a region where a microcavity will be formed. An etch stopper 305 is deposited on the formed sacrificial layer 300.

As shown in FIG. 4, a transparent conductive material 270′ is deposited on the sacrificial layer 300 and the etch stopper 305, and a photoresist (PR) is deposited thereon and exposed and developed to form a photoresist pattern 275. The photoresist pattern 275 is a pattern to etch a cutout 271 of the common electrode 270.

The transparent conductive material 270′ is etched according to the photoresist pattern 275 to form the common electrode 270 having the cutout 271 as shown in FIG. 5. After forming the common electrode 270, the remaining photoresist pattern 275 is soaked in an etchant (for example, a photoresist stripper) to be removed. At this time, since the sacrificial layer 300 is also formed of the photoresist (PR), the etch stopper 305 is formed for the sacrificial layer 300 to not be also removed when removing the photoresist pattern 275.

As shown in FIG. 5, an inorganic insulating material such as silicon nitride (SiNx) is formed on the common electrode 270 to form a lower insulating layer 311. The lower insulating layer 311 may be formed throughout the entire region.

A roof layer 312 is formed on the lower insulating layer 311. The roof layer 312 may have a pattern that is removed at a region where a liquid crystal injection hole (not shown) will be formed by the exposure and the developing.

After forming the roof layer 312, an upper insulating layer 313 is formed thereon. The upper insulating layer 313 may be formed throughout the entire region.

The upper insulating layer 313, the lower insulating layer 311, the common electrode 270, and the etch stopper 305 corresponding to the region (corresponding to the liquid crystal injection hole) where the roof layer 312 is not formed are etched to form the liquid crystal injection hole and to expose the sacrificial layer 300. At this time, the photoresist (PR) is formed on the upper insulating layer 313 such that only the position of the liquid crystal injection hole may be exposed.

The exposed sacrificial layer 300 is wet-etched or dry-etched to form a microcavity 301. When wet-etching the sacrificial layer 300, the photoresist (PR) on the upper insulating layer 313 may also be removed.

As shown FIG. 1, the liquid crystal molecules 310 are injected to the microcavity 301 by the capillary force to form the liquid crystal layer 3. At this time, the alignment layer may be formed before the liquid crystal layer 3 is injected by the capillary force.

The liquid crystal injection hole is sealed by a capping layer (not shown) for the liquid crystal layer 3 to not leak outside.

Meanwhile, a polarizer (not shown) may be attached to the lower and upper insulating layers 311 and 313 of the insulation substrate 110.

In the above manufacturing method, the sacrificial layer 300 is protected by the etch stopper 305. Also, when etching the sacrificial layer 300, the photoresist (PR) positioned on the upper insulating layer 313 may also be wet-etched and removed.

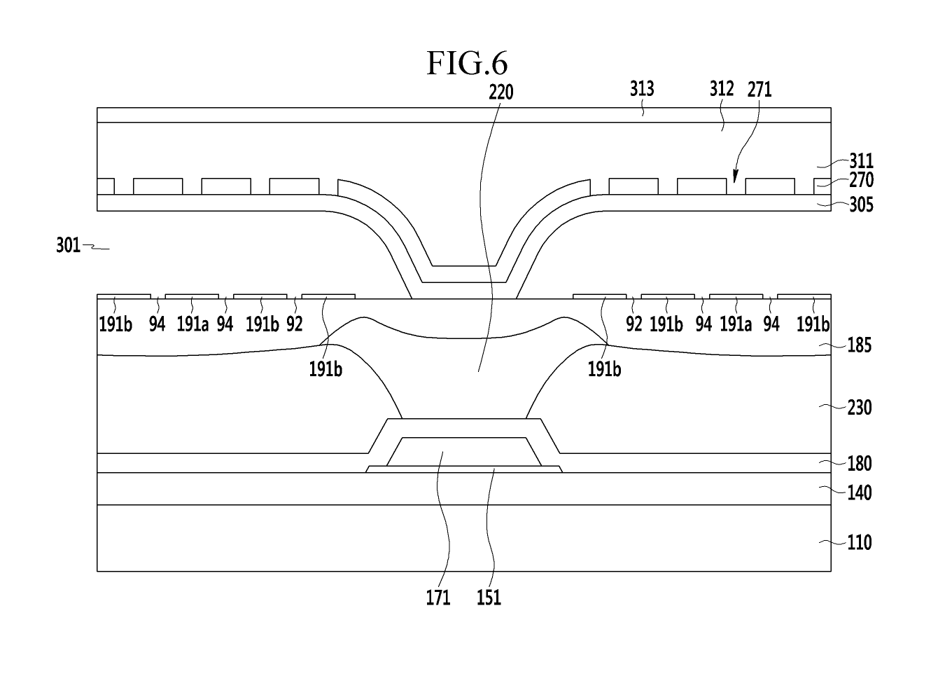

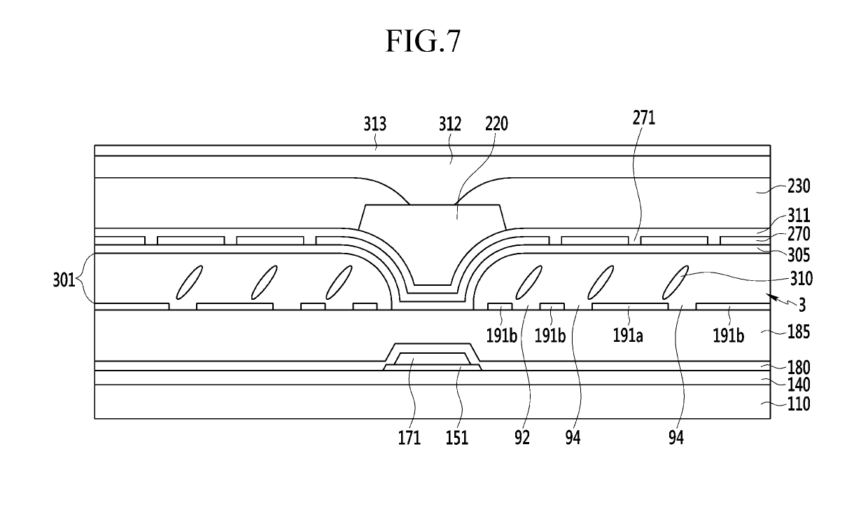

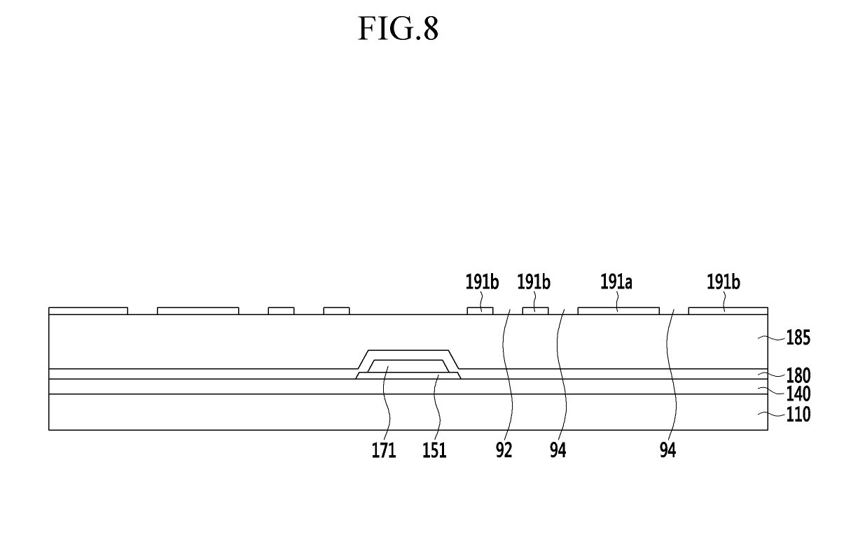

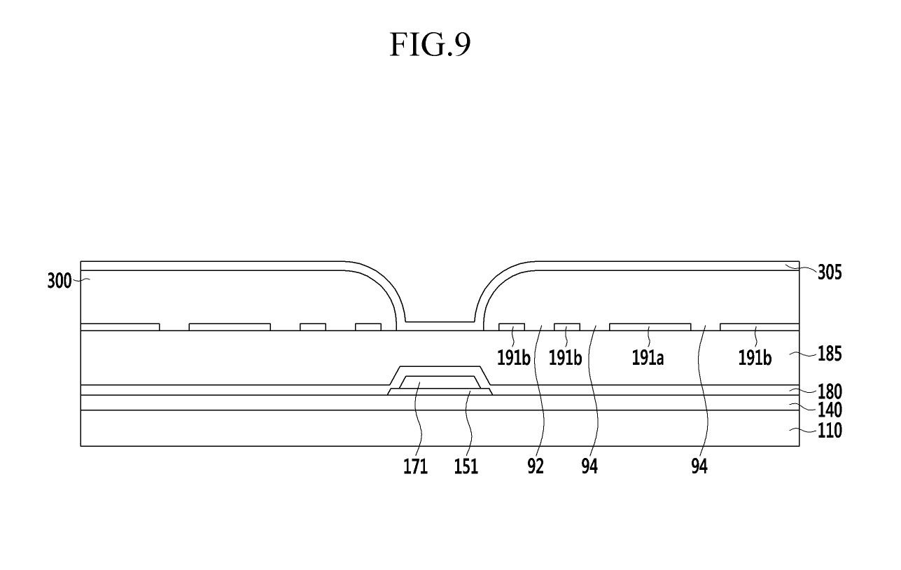

An exemplary embodiment in which the light blocking member 220 and the color filter 230 are positioned on the microcavity 301 is described with FIG. 7, FIG. 8, FIG. 9, FIG. 10, FIG. 11, FIG. 12, FIG. 13, and FIG. 14.

FIG. 7 is a cross-sectional view of a liquid crystal display according to an exemplary embodiment of the present invention.

In the structure of FIG. 7, differently from the structure of FIG. 1, the light blocking member 220 and the color filter 230 are positioned on the microcavity layer. That is, the light blocking member 220 is formed on the lower insulating layer 311, and the color filter 230 is formed at the opening of the light blocking member 220. According to an exemplary embodiment, the up and down relation of the light blocking member 220 and the color filter 230 may be exchanged.

A roof layer 312 is formed on the light blocking member 220 and the color filter 230. The roof layer 312 has a supporting function to form the microcavity layer. An upper insulating layer 313 is formed on the roof layer 312.

Also, in FIG. 7, the liquid crystal layer 3 is formed in the microcavity layer, and the domain divider (the cutout 92, 271 in FIG. 7) are respectively formed in two sub-pixel electrodes 191a and 191b under the liquid crystal layer and the common electrode 270 on the liquid crystal layer to control the liquid crystal molecules 310 included in one pixel into the various directions for forming multi-domain, thereby improving lateral visibility. In the present exemplary embodiment, the number of directions in which the liquid crystal molecules 310 are inclined in one pixel is four. Further, referring to FIG. 15, two sub-pixel electrodes 191a and 191b may be applied with different voltages.

Furthermore, in the exemplary embodiment of FIG. 7, an etch stopper 305 is formed on the microcavity 301. The etch stopper 305 is a layer protecting a sacrificial layer 300 to not be etched when etching the photoresist pattern 275 that is used to form the cutout 271 in the overlying common electrode 270 in the manufacturing process, as described in detail below with reference to FIG. 10. The etch stopper 305 may be a material that is not etched under the etching of the common electrode 270, and various materials including the inorganic insulator such as silicon nitride (SiNx) and silicon oxide (SiOx) may be used. Also, if a material that is etched under the etching of the common electrode 270 is used as the etch stopper 305, the etch stopper 305 may be formed with sufficient thickness to protect the underlying sacrificial layer 300.

A manufacturing method of the liquid crystal display according to the exemplary embodiment according to FIG. 7 will be described with reference to FIG. 8, FIG. 9, FIG. 10, FIG. 11, FIG. 12, FIG. 13, and FIG. 14.

FIG. 8, FIG. 9, FIG. 10, FIG. 11, FIG. 12, FIG. 13, and FIG. 14 are cross-sectional views according to a manufacturing sequence of the liquid crystal display of FIG. 7.

As shown in FIG. 8, a gate line 121 (referring to FIG. 15) is formed on an insulation substrate 110 made of transparent glass or plastic, and a gate insulating layer 140 is deposited thereon. A semiconductor material and a metal for a data line are sequentially deposited and are patterned by using one mask (a slit mask or a transflective mask) to form a semiconductor 151 and a source and a drain electrode (referring to 173a, 173b, 175a, and 175b of FIG. 15), and a data line 171. The first passivation layer 180 and the second passivation layer 185 covering them are formed thereon. According to an exemplary embodiment, one of the first passivation layer 180 and the second passivation layer 185 may be omitted.

The first passivation layer 180 and the second passivation layer 185 have a contact hole (185a and 185b of FIG. 15) exposing the drain electrode. Next, a transparent conductive material is deposited and etched on the second passivation layer 185 to form two sub-pixel electrodes 191a and 191b having a gap 94 and a cutout 92. Here, each sub-pixel electrode is connected to the drain electrode through the contact hole (referring to 185a and 185b of FIG. 15).

In FIG. 8, steps of forming the wiring, the thin film transistor, the pixel electrode, and the common electrode are omitted and are shown as one view. This structure may be realized by various exemplary embodiments.

As shown in FIG. 9, a sacrificial layer 300 is formed by using a photoresist (PR). That is, a photoresist (PR) material is deposited, and exposed and developed to form the sacrificial layer 300. The sacrificial layer 300 is removed later thereby forming a region where a microcavity will be formed. An etch stopper 305 is deposited on the formed sacrificial layer 300.

As shown in FIG. 10, a transparent conductive material 270′ is deposited on the sacrificial layer 300 and the etch stopper 305, and a photoresist (PR) is deposited thereon and exposed and developed to form a photoresist pattern 275. The photoresist pattern 275 is a pattern to etch a cutout 271 of the common electrode 270.

The transparent conductive material 270′ is etched according to the photoresist pattern 275 to form the common electrode 270 having the cutout 271 as shown in FIG. 11. After forming the common electrode 270, the remaining photoresist pattern 275 is removed by wet-etching. At this time, since the sacrificial layer 300 is also formed of the photoresist (PR), the etch stopper 305 is formed for the sacrificial layer 300 to not be also removed when removing the photoresist pattern 275.

As shown in FIG. 11, an inorganic insulating material such as silicon nitride (SiNx) is formed on the common electrode 270 to form a lower insulating layer 311. The lower insulating layer 311 may be formed throughout the entire region.

A light blocking member 220 having an opening is formed on the lower insulating layer 311. The light blocking member 220 may have a pattern that is removed at a position where the liquid crystal injection hole will be formed.

As shown in FIG. 12, a color filter 230 is formed at the opening of the light blocking member 220. The color filter 230 may have a pattern that is removed at a position where the liquid crystal injection hole will be formed.

As shown in FIG. 13, a roof layer 312 is formed on the light blocking member 220 and the color filter 230. The roof layer 312 may have a pattern that is removed at a region where the liquid crystal injection hole will be formed by the exposure and developing.

After forming the roof layer 312, an upper insulating layer 313 is formed thereon. The upper insulating layer 313 may be formed throughout the entire region.

The upper insulating layer 313, the lower insulating layer 311, the common electrode 270, and the etch stopper 305 corresponding to the region (corresponding to the liquid crystal injection hole) where the roof layer 312 is not formed are etched to form the liquid crystal injection hole (not shown) and to expose the sacrificial layer 300. At this time, the photoresist (PR) is formed on the upper insulating layer 313 such that only the position of the liquid crystal injection hole may be exposed.

The exposed sacrificial layer 300 is wet-etched or dry-etched to form a microcavity 301. When wet-etching the sacrificial layer 300, the photoresist (PR) on the upper insulating layer 313 may also be removed.

As shown FIG. 14, the liquid crystal molecules 310 are injected to the microcavity 301 by the capillary force to form the liquid crystal layer 3. The alignment layer may be formed before the liquid crystal layer 3 is injected by the capillary force.

The liquid crystal injection hole is sealed by a capping layer (not shown) for the liquid crystal layer 3 to not leak outside.

Meanwhile, a polarizer (not shown) may be attached on the lower and upper insulating layers 311 and 313 of the insulation substrate 110.

In an exemplary manufacturing method, the sacrificial layer 300 is protected by the etch stopper 305. Also, when etching the sacrificial layer 300, the photoresist (PR) positioned on the upper insulating layer 313 may also be wet-etched and removed.

An arrangement of a pixel structure of a liquid crystal display according to an exemplary embodiment of the present invention will be described with reference to FIG. 15.

FIG. 15 is a layout view of a pixel structure of a liquid crystal display according to an exemplary embodiment of the present invention.

A liquid crystal display according to an exemplary embodiment of the present invention includes a liquid crystal layer positioned inside the microcavity formed on one insulation substrate.

A plurality of gate lines 121 and a plurality of storage electrode lines 131 are formed on an insulation substrate 110 made of transparent glass.

The gate lines 121 mainly extending in a transverse direction are separated from each other and transmit a gate signal. Each gate line 121 includes a plurality of protrusions forming a plurality of gate electrodes 124a and 124b. Each gate line 121 may include an end having a wide area for connection with an external driving circuit.

The storage electrode line 131 extends in a transverse direction and includes a storage electrode 137 protruding up and down and blocking members 134 and 135. The storage electrode line 131 is applied with a predetermined voltage such as a common voltage applied to a common electrode 270 of the common electrode panel of the liquid crystal display.

A gate insulating layer 140 made of silicon nitride is formed on the gate line 121 and the storage electrode line 131.

A plurality of semiconductor islands 154 that are made of hydrogenated amorphous silicon (a-Si), polysilicon, or so on, are formed on the gate insulating layer 140. According to an exemplary embodiment, as shown in FIG. 1 and FIG. 7, a semiconductor layer may also be formed under a position where the data lines 171a and 171b are formed.

A plurality of pairs of ohmic contact islands that may be made of a material such as n+ hydrogenated amorphous silicon in which an n-type impurity such as phosphorus is doped with a high concentration, or of silicide, are formed on the semiconductor 154. The ohmic contact islands are respectively positioned in pairs on the semiconductor 154.

A plurality of pairs of first and second data lines 171a and 171b, a plurality of pairs of first and second drain electrodes 175a and 175b, and a plurality of pairs of first and second electrode members 177a and 177b are formed on the semiconductor 154 and the gate insulating layer 140.

The data lines 171a and 171b mainly extending in a longitudinal direction intersect the gate line 121 and the storage electrode line 131 and transmit the data voltage. The data lines 171a and 171b respectively include a plurality of source electrodes 173a and 173b extending toward the gate electrodes 124a and 124b, and include an end (not shown) having an expanded width for connection with other layers or an external driving circuit.

The drain electrodes 175a and 175b are separated from the data lines 171a and 171b and face the source electrodes 173a and 173b with respect to the gate electrodes 124a and 124b.

The first and second drain electrodes 175a and 175b have a bar end positioned on the semiconductor 154, and the bar end is partially enclosed by the source electrodes 173a and 173b curved with a “U” shape.

The first drain electrode 175a starts from the bar end, extends substantially in parallel to the first data line 171a and is then curved, and extends in parallel to the gate line 121, and includes an expansion having a wide area.

The second drain electrode 175b includes a portion substantially parallel to the first data line 171a and a portion that is lightly curved.

The first and second electrode members 177a and 177b are separated from the first and second drain electrode 175a and 175b and overlap the storage electrode 137.

The first/second gate electrode 124a/124b, the first/second source electrode 173a/173b, and the first/second drain electrode 175a/175b form a first/second thin film transistor (TFT) Qa/Qb along with the protrusion/semiconductor island 154a/154b, and the channel of the first/second thin film transistor Qa/Qb is formed in the semiconductor 154 between the first/second source electrode 173a/173b and the first/second drain electrode 175a/175b.

A passivation layer 180 is formed on the data lines 171a and 171b, the drain electrodes 175a and 175b, the first and second electrode members 177a and 177b, and the exposed semiconductor 154. The passivation layer 180 is made of an inorganic insulator such as silicon nitride or silicon oxide, an organic insulator, or a low dielectric insulating material.

The passivation layer 180 has a plurality of contact holes 185a, 185b, 187a, and 187b respectively exposing the drain electrodes 175a and 175b and the first and second electrode members 177a and 177b.

A plurality of pixel electrodes 191 including the first and second sub-pixel electrodes 191a and 191b are formed on the passivation layer 180. They may be formed of the transparent conductive material such as Indium Tin Oxide (ITO) or Indium Zinc Oxide (IZO).

The first /the second sub-pixel electrodes 191a/191b are physically and electrically connected to the first /the second drain electrodes 175a/175b through the contact holes 185a/185b thereby receiving the data voltage from the first/the second drain electrodes 175a/175b. A pair of sub-pixel electrodes 191a and 191b are applied with different predetermined data voltages for one input image signal, and the magnitude thereof may be determined according to a size and shape of the sub-pixel electrodes 191a and 191b. The areas of the sub-pixel electrodes 191a and 191b may be different from each other. As one example, the second sub-pixel electrode 191b may be applied with a higher voltage than the first sub-pixel electrode 191a and may have a smaller area than the first sub-pixel electrode 191a.

The sub-pixel electrodes 191a and 191b applied with the data voltage generate an electric field along with the common electrode 270 to determine the arrangement of the liquid crystal molecules of the liquid crystal layer 3 between the electrodes 191a/191b and 270.

A pair of first and second sub-pixel electrodes 191a and 191b forming one pixel electrode 191 are engaged with each other with a gap 94 therebetween, and the first sub-pixel electrode 191a is inserted into the center of the second sub-pixel electrode 191b.

The first and second sub-pixel electrodes 191a and 191b respectively include a cutout 92. The cutout 92 of the second sub-pixel electrode 191b may be divided into a center cutout, an upper cutout, and a lower cutout, and the second sub-pixel electrode 191b is divided into a plurality of domain regions by the cutout 92. The cutout 92 is substantially symmetrical to the storage electrode line 131.

The upper and lower cutouts 92 obliquely extend from the right edge of the pixel electrode 191 to the left edge, the upper edge, or the lower edge. The upper and lower cutouts 92 are respectively disposed on the lower-half portion and the upper-half portion with respect to the storage electrode line 131. The upper and lower cutouts 92 are inclined with respect to the gate line 121 or one edge of the insulation substrate 110 by an angle of about 45°, and extend perpendicularly to each other. Meanwhile, the gap 94 is inclined with respect to the gate line 121 or one edge of the insulation substrate 110 by an angle of about 45°.

The central cutout 92 extends along the storage electrode line 131 and has an entrance on the left edge thereof. The central cutout 92 has a central horizontal portion and a pair of slanting portions. The central horizontal portion extends from the right edge of the pixel electrode 191 to the left edge of the pixel electrode 191, along the storage electrode line 131. The pair of slanting portions extend from the end of the central horizontal portion toward the left side of the pixel electrode, while being substantially parallel to the lower and upper cutouts 92, respectively.

Thus, the lower half portion of the pixel electrode 191 is partitioned into five regions by the central cutout 92, the gap 94, and the lower cutout 92, and the upper half portion thereof is partitioned into five regions by the central cutout 92, the gap 94, and the lower cutout 92. The number of partitioned regions or the number of cutouts may depend on design factors, such as the size of the pixel, a length ratio of the horizontal side and vertical side of the pixel electrode, or the type or characteristics of the liquid crystal layer 3.

The first sub-pixel electrode 191a includes a longitudinal edge parallel to the data lines 171a and 171b. The blocking members 134 and 135 overlap the first sub-pixel electrode 191a near the longitudinal edge.

A light blocking member 220 is formed on or under the microcavity 301. The light blocking member 220 is referred to as a black matrix and prevents light leakage. The light blocking member 220 has a portion corresponding to the data line 171 and a plane portion corresponding to the thin film transistor, prevents light leakage between the pixel electrodes 191, and defines an opening facing the pixel electrode 191. However, the light blocking member 220 may have a plurality of openings (not shown) facing the pixel electrode 191 and having almost the same shape as the pixel electrode 191.

A plurality of color filters 230 are formed in the opening of the light blocking member 220 on or under the light blocking member 220. The color filters 230 may extend according to a column of the pixel electrode 191 in the longitudinal direction. Each of the color filters 230 may display one of primary colors, such as red, green, and blue.

Meanwhile, a common electrode 270 is formed on the microcavity 301.

The common electrode 270 has a cutout 271 and is formed of the transparent conductor such as ITO and IZO.

The cutout 271 of the common electrode 270 faces one pixel electrode 191 and includes first and second central cutouts, an upper cutout, and a lower cutout. The cutouts are respectively disposed between the adjacent cutouts 92 and gap 94 of the pixel electrode 191. Also, each cutout 271 includes at least one oblique branch parallel to the lower and upper cutouts 92 of the pixel electrode 191. The cutout 271 of the common electrode 270 may form an angle of about 45° with respect to the gate line 121 or one edge of the insulation substrate 110.

The lower and upper cutouts 271 of the common electrode 270 may respectively include an oblique branch, a longitudinal branch, and a transverse branch. Also, the first and second central cutouts 271 of the common electrode 270 may include a central transverse branch, a pair of oblique branches, and a pair of end longitudinal branches.

The cutout 92 and the gap 94 of the pixel electrode 191 and the cutout 271 of the common electrode have a notch of a triangular shape. The notches may have a quadrangular, trapezoidal, or semicircular shape, and may be convex or concave. These notches determine the arrangement direction of the liquid crystal molecules 31 disposed at the boundary of the region corresponding to the cutouts 92 and 271 and the gap 94.

The number, structure, and direction of the cutouts 271 may be changed according to design.

An alignment layer may be formed in the microcavity 301, and it may be a vertical alignment layer.

Polarizers may be attached on and under the microcavity 301, and it is preferable that transmissive axes of the two polarizers may be orthogonal to each other and that any one transmissive axis of them is parallel to the gate line 121.

The liquid crystal display may include a backlight unit (not shown) providing light.

The liquid crystal layer 3 positioned in the microcavity 301 has negative dielectric anisotropy. The liquid crystal molecules of the liquid crystal layer 3 may be arranged such that longitudinal axes thereof are perpendicular to the surfaces of the two panels in the absence of an electric field. Accordingly, in the absence of an electric field, the incident light may not be passed through the crossed polarizers and may be blocked.

If the common voltage is applied to the common electrode 270 and the data voltage is applied to the pixel electrode 191, a vertical electric field is generated. Thus, liquid crystal molecules of the liquid crystal layer 3 change directions so that the major axes thereof become perpendicular to the direction of the electric field in response to the electric field. Hereinafter, both the pixel electrode 191 and the common electrode 270 are commonly referred to as “field generating electrodes”. The cutouts 92 and the gap 94 of the pixel electrode of the field generating electrodes 191 and 270, and the cutout 271 of the common electrode, distort the electric field to have a horizontal component that determines the tilt directions of the liquid crystal molecules 310. The horizontal component of the main electric field is perpendicular to the oblique edges of the cutouts 92 and 271 and the oblique edges of the pixel electrode 191.

Also, as shown in FIG. 15, one pixel area is divided into a plurality of domain regions by the cutouts 92 and 271 of the domain divider, and each domain region has two major edges that form an oblique angle with the major edge of the pixel electrode 191. The liquid crystal molecules on each domain region are mainly inclined in the direction perpendicular to the major edge, and there are approximately four inclined directions. As the inclination directions of the liquid crystal molecules 310 are diversified, the viewing angle of the liquid crystal display becomes widened.

At least one cutout 92 or 271 can be replaced with a protrusion or a depression, and the shape and disposition of the cutouts 92 and 271 can be modified.

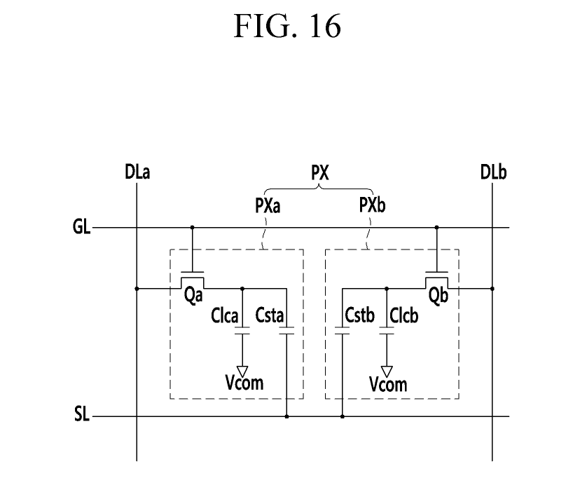

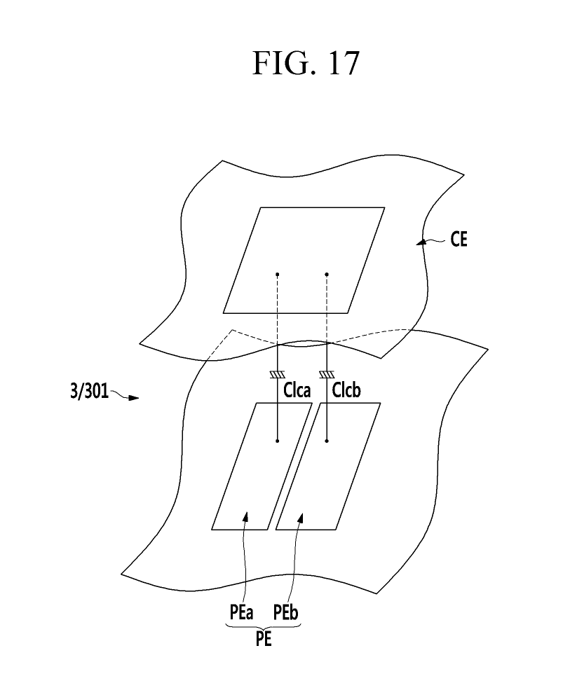

The structure of FIG. 15 except for the domain divider may be simplified as shown in FIG. 16 or FIG. 17.

FIG. 16 is an equivalent circuit diagram of one pixel of a liquid crystal display according to an exemplary embodiment of the present invention, and FIG. 17 is a view of two electrodes for two sub-pixels of a liquid crystal display according to an exemplary embodiment of the present invention.

In FIG. 16, one pixel structure will be described through a circuit diagram.

A liquid crystal panel assembly according to the present exemplary embodiment includes signal lines including a plurality of gate lines GL, a plurality of pairs of data lines DLa and DLb, and a plurality of storage electrode lines SL, and a plurality of pixels PX connected thereto.

Each of the pixels PX has a pair of sub-pixels PXa and PXb, and each of the sub-pixels PXa/PXb has a switching element Qa/Qb that is connected to a corresponding gate line GL and a corresponding data line DLa/DLb, a liquid crystal capacitor Clca/Clcb that is connected to the switching element Qa/Qb, and a storage capacitor Csta/Cstb that is connected to the switching element Qa/Qb and the storage electrode line SL.

Each of the switching elements Qa/Qb also corresponds to a three-terminal element, such as a thin film transistor, that is included in the lower panel 100, and has a control terminal connected to a gate line GL, an input terminal connected to a data line DLa/DLb, and an output terminal connected to the liquid crystal capacitor Clca/Clcb and the storage capacitor Csta/Cstb.

The storage electrode line SL and the pixel electrode PE provided on the lower panel 100 overlap each other with an insulator interposed therebetween to form the storage capacitor Csta/Cstb that supplements the liquid crystal capacitor Clca/Clcb, and a predetermined voltage such as the common voltage Vcom is applied to the storage electrode line SL. However, the sub-pixel electrode PEa/PEb may overlap a previous gate line with the insulator interposed therebetween to form the storage capacitor Csta/Cstb.

In this liquid crystal display, input image signals R, G, and B for one pixel PX may be converted into the output image signal DAT for two sub-pixels PXa and PXb and may be transmitted to the two sub-pixels PXa and PXb. At this time, a combination gamma curve of two sub-pixels PXa and PXb may be close to a reference gamma curve at a front side.

Meanwhile, referring to FIG. 17, only an upper common electrode CE and a lower pixel electrode PE are shown with reference to the liquid crystal layer 3 inside the microcavity 301 in FIG. 17.

One pixel PE includes a pair of sub-pixels PXa and PXb. The sub-pixels PXa and PXb respectively include a switching element (not shown) connected to the signal lines (a gate line and a data line) and liquid crystal capacitors Clca and Clcb connected thereto. Although not shown, the sub-pixels PXa and PXb may respectively include the storage capacitors Cst.

In this case, the switching element as a three-terminal element such as a thin film transistor formed on an insulation substrate 110 includes a control terminal connected to the gate line, an input terminal connected to the data line, and an output terminal connected to the liquid crystal capacitors Clca and Clcb and the storage capacitor Cst.

The liquid crystal capacitors Clca/Clcb include the sub-pixel electrodes PEa/PEb and the common electrode CE as two terminals, and the liquid crystal layer 3 between the sub-pixel electrodes PEa/PEb and the common electrode CE functions as a dielectric material. The pair of sub-pixel electrodes PEa and PEb are separated from each other and form one pixel electrode PE. The common electrode CE is formed on the whole surface on the microcavity 301 and receives the common voltage Vcom. The liquid crystal layer 3 has negative dielectric anisotropy. The liquid crystal molecules of the liquid crystal layer 3 may be arranged such that a longitudinal axis of the liquid crystal molecules is perpendicular to the surfaces of the two display panels in the absence of an electric field.

A separated signal line (not shown) and the pixel electrode PE overlap each other with an insulator interposed therebetween to form the storage capacitor Cst that supplements the liquid crystal capacitor Clc, and a predetermined voltage such as the common voltage Vcom is applied to the separated signal line. However, the pixel electrode PE may overlap a previous gate line with the insulator interposed therebetween to obtain the storage capacitor Cst.

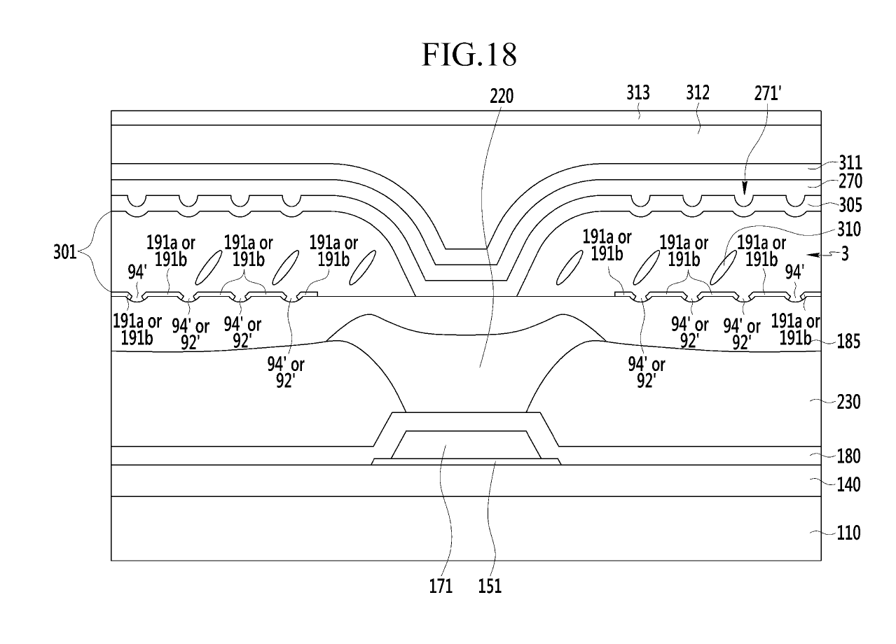

An exemplary embodiment in which protrusions 271′ and depressions 92′ 94′ are used as the domain divider is described with FIG. 18.

FIG. 18 is a cross-sectional view of a liquid crystal display according to another exemplary embodiment of the present invention.

In the structure of FIG. 18, different domain dividers are used in one embodiment. In this embodiment, the upper domain dividers are protrusions 271′ and the lower domain dividers are depressions 92′ and 94′. The etch stopper 305 is protruded towards the liquid crystal layer 3 due to the protrusions 271′. The second passivation layer 185 also has depressed parts below the depressions 92′ and 94′. According to embodiments, different combinations of the domain dividers of the pixel electrode and the common electrode may be used.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a substrate;
a microcavity disposed on the substrate;
a pixel electrode disposed in the microcavity and on the substrate, the pixel electrode comprising a first domain divider;
a liquid crystal layer disposed in the microcavity layer; and
a common electrode disposed on the liquid crystal layer and comprising a second domain divider.

2. The liquid crystal display of claim 1, further comprising an etch stopper disposed between the liquid crystal layer and the common electrode,
wherein the etch stopper comprises an inorganic insulator.

3. The liquid crystal display of claim 1, wherein the first domain divider comprise a cutout, a protrusion, a notch, or a depression, and the second domain divider comprise a cutout, a protrusion, a notch, or a depression.

4. The liquid crystal display of claim 3, wherein the second domain divider of the common electrode is positioned between the first domain divider of the pixel electrode.

5. The liquid crystal display of claim 3, wherein the second domain divider of the common electrode is a different type of domain divider than the first domain divider of the pixel electrode.

6. The liquid crystal display of claim 4, wherein at least one second domain divider of the common electrode is parallel to at least one of the first domain divider of the pixel electrode.

7. The liquid crystal display of claim 6, wherein the first and second domain divider form an angle of 45° with respect to one edge of the substrate.

8. The liquid crystal display of claim 1, wherein the pixel electrode comprises at least two sub-pixel electrodes in a pixel, and the sub-pixel electrodes are separated via a gap.

9. The liquid crystal display of claim 8, wherein the gap forms an angle of 45° with respect to one edge of the substrate.

10. The liquid crystal display of claim 1, further comprising a roof layer supporting the microcavity on the microcavity layer.

11. The liquid crystal display of claim 10, further comprising a lower insulating layer covering the second domain divider of the common electrode and disposed between the roof layer and the common electrode.

12. The liquid crystal display of claim 1, further comprising:
a color filter disposed between the substrate and the pixel electrode, or on the common electrode; and
a light blocking member disposed between the substrate and the pixel electrode, or on the microcavity layer.

13. A method of manufacturing a liquid crystal display, comprising:
forming a pixel electrode on a substrate, the pixel electrode comprising a first domain divider;
forming a sacrificial layer on the pixel electrode;
forming an etch stopper on the sacrificial layer;
forming a common electrode on the etch stopper, the common electrode comprising a second domain divider;
forming a roof layer on the common electrode;
forming a microcavity by removing the sacrificial layer; and
injecting a liquid crystal to the microcavity layer.

14. The method of claim 13, wherein the etch stopper comprises an inorganic insulator.

15. The method of claim 13, wherein the forming of the common electrode comprises:
forming a photoresist pattern on the common electrode;
etching the common electrode using the photoresist pattern as a mask; and
removing the photoresist pattern by using an etchant,
where the etch stopper protects the sacrificial layer from the etchant.

16. The method of claim 13, wherein the first domain divider comprise a cutout, a protrusion, a notch, or a depression, and the second domain divider comprise a cutout, a protrusion, a notch, or a depression.

17. The method of claim 16, wherein the second domain divider of the common electrode is positioned between the first domain divider of the pixel electrode.

18. The method of claim 13, wherein in the forming of the pixel electrode, the pixel electrode comprised in one pixel is formed for two sub-pixel electrodes to be separated via a gap therebetween.

19. The method of claim 18, wherein the gap forms an angle of 45° with respect to one edge of the substrate.

20. The method of claim 13, further comprising forming a lower insulating layer covering the common electrode having the domain divider before forming the roof layer.
